(19) United States
(12) Patent Application Publication
(10) Pub. No.: US 2014/0030413 A1
(43) Pub. Date: Jan. 30, 2014

(54) Frozen Challah Dough with Protrusion or Marking or Separated Piece for Observing the Mitzvah of Hafrashat Challah (Separating of Challah)

(71) Applicant: Fischel David Offman, Mitspe Adi (IL)

(72) Inventor: Fischel David Offman, Mitspe Adi (IL)

(21) Appl. No.: 13/919,023

(22) Filed: Jun. 17, 2013

(30) Foreign Application Priority Data
Jun. 19, 2012 (IL) 250501

(51) Int. Cl. A21D 10/02

(52) U.S. Cl. CPC A21D 10/02
USPC 426/549

(57) ABSTRACT

Frozen challah dough that is intended for oven baking and has a protrusion or a small portion marked off or a piece separated from it, which are designed to be removed before baking in such a way that enables the use to perform the Hafrashat Challah Mitzvah.

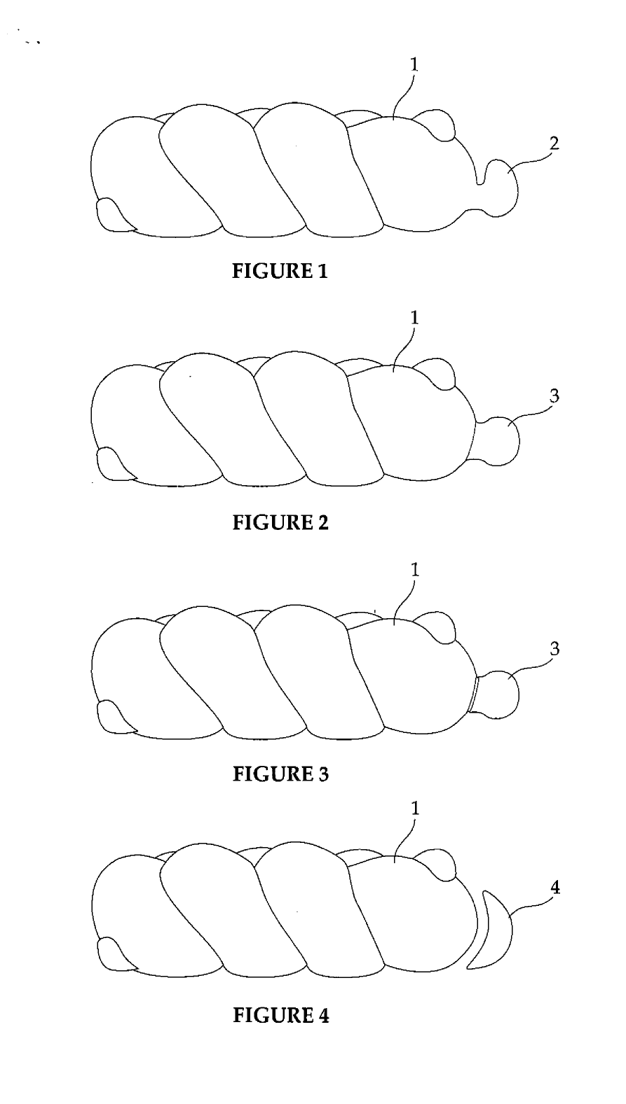

### TECHNICAL FIELD

The present invention refers to frozen challah dough that is intended for oven baking and has a protrusion, or a marking that marks off a small portion, or a small piece that is separated from the challah itself, which is intended to be removed or set aside from the challah before baking, in such a way that enables the user to perform the Hafrashat Challah Mitzvah (Separating of Challah).

### BACKGROUND ART

The Hafrashat Challah Mitzvah was given in the Torah: “When ye come into the land whither I bring you, then it shall be, that, when ye eat of the bread of the land, ye shall offer up an heave offering unto the Lord. Ye shall offer up a cake of the first of your dough for an heave offering: as ye do the heave offering of the threshing floor, so shall ye heave it. Of the first of your dough ye shall give unto the Lord an heave offering in your generations.”

The Torah commands any person preparing dough to set aside a portion of it and to offer that portion as a gift to the priests, as one of the twenty-four kohanic gifts. After the destruction of Jerusalem it became customary to burn the separated challah portion rather than present it as a priestly gift. Hafrashat Challah is a highly regarded Mitzvah, and even needy people, who are exempt from donating a tithe, must observe it.

The Hafrashat Challah Mitzvah is one of three Mitzvot given to women, and it is therefore traditionally customary for the women who prepare the dough to observe this Mitzvah. It is also customary for the woman performing this Mitzvah to say a blessing while separating the challah, which is believed to cleanse away her entire family's evil deeds and atone for their sins.

This explains why Hafrashat Challah is such a well-known and important Mitzvah to the Jewish religiously-observant public. In modern times people do not usually prepare their own challah and bread dough at home, and so women do not have many opportunities to perform this Mitzvah. Moreover, even families that used to bake their own challahs at home, especially on Friday and holiday eves, have stopped making their own dough since an extensive industry has developed in recent years that involves the sale of ready-made frozen challah and bread intended for home baking (these, in fact, are frozen dough shaped like a challah or a loaf of bread that is sold in stores and the customer is required only to defrost and bake). This trend has made the Hafrashat Challah Mitzvah even less feasible to perform.

Some women, however, still wish to perform the Mitzvah because of its ethically redeeming merits for the entire family. These women take the trouble of preparing their own bread and challah dough for Shabbat, almost entirely for the purpose of performing the Mitzvah. This constitutes a considerable bother and source of difficulty since the Mitzvah may be performed only after a large enough quantity of dough is prepared, and on a Friday, when the kitchen is primarily set up for Shabbat cooking.

US patent application 2004086601 describes a problem which occurs when the user wishes to form cookie in a circular shape from piece of dough prior to baking. The solution describes is US patent application 2004086601 relates to a thin sheet of dough from which the user can separates to many small pieces and to form from each piece a shape of a cookie. This thin sheet of dough can not provide a solution for the problem subject matter of this invention due to the fact that it is impossible to back a Challah from this thin dough sheet.

It is therefore clear that performing this Mitzvah is problematic. The invention, subject of the present patent, offers a solution for this problem and enables any woman who wishes to perform the Hafrashat Challah Mitzvah to do so easily, saving her the trouble of having to prepare her own dough.

### SUMMERY OF THE INVENTION

The present invention provides frozen challah dough that is ready and intended for oven baking which has in one end of the said frozen challa a protrusion or piece of dough that intends to be removed before baking in the way that enables the user to perform the Hafrashat Challah Mitzvah. In addition, the present invention provides frozen challah dough that is ready and intended for oven baking which has in one end of the said frozen challa a small portion of the said frozen challah marked off, which intends to be remove before baking in the way that enables the user to perform the Hafrashat Challah Mitzvah.

### DESCRIPTION OF THE DRAWINGS

The drawings attached to the present application are not intended to limit the scope of the invention and the possible ways of its application. The drawings are intended only to illustrate the invention and constitute only one of many possible ways of its application.

Drawing No. 1 depicts the frozen challah (1), including a protrusion (2).

Drawing No. 2 depicts the frozen challah (1), including a marking (3) in the form of a perimetrical line.

Drawing No. 3 depicts the frozen challah (1), including a marking (3) in the form of a perimetrical groove.

Drawing No. 4 depicts the frozen challah (1), including a small piece (4) that is separated from the challah.

### The Invention

The main objective of this invention is to provide frozen challah dough (1) that is intended for oven baking and has a protrusion (2) designed to be removed prior to baking, or a marking (3) that marks off a small piece of the challah intended to be removed prior to baking, or a separated piece (4) that is designed to be removed prior to baking, in a way that enables the user to perform the Hafrashat Challah Mitzvah on the frozen challah.

The present invention refers to frozen challah dough (1) that has a protrusion (2) or a marking (3) or a separated piece (4) and is designed to enable the user to perform the Hafrashat Challah Mitzvah. The term “frozen challah” refers to various kinds of dough that are shaped like a challah or a loaf of bread, and to any other kind of baked goods made from frozen dough, that are sold to the general public and are intended for oven baking. It is customary nowadays to sell frozen challahs for home baking in grocery stores. The present invention makes use of existent technology, but in a way that the frozen challah (1) has a protrusion (2), or a marking (3) that marks off a small portion, or a separated piece (4), which the user removes before baking. When the frozen challah (1) has a protrusion (2), this protrusion is the portion that is designated to be set aside from the dough (i.e. from the frozen challah), enabling the user to properly perform the Hafrashat Challah Mitzvah.

As mentioned previously, the frozen challah (1) may have a marking (3) that marks off a small portion of the frozen challah (1) intended for removal, as an indication and a reminder for the woman who wishes to perform the Mitzvah.

The marking (3) may be of various kinds, such as a perimetrical line; a perimetrical scoring; a distinctive color of the removable portion; a perimetrical thread that marks off the portion to be removed and even helps cut it off; a perimetrical groove at the end of the frozen challah that enables the user to break off the removable portion, and so on. The marking (3) or the separated piece (4) serve as indication for the woman of the particular portion to be removed from the frozen challah (1) prior to baking, thus enabling her to properly perform the Hafrashat Challah Mitzvah. Moreover, the marking (3) or the separated piece (4) serves as a warning that a portion has not yet been set aside from the frozen challah (1), and therefore it must not be eaten before such a piece has been separated and set aside.

The drawings attached to the present application, which are described below, are intended only to illustrate the invention and are not intended to limit the scope of the invention or its interpretation. Drawing No. 1 depicts a frozen challah (1) with a protrusion (2). Drawing No. 2 depicts a frozen challah (1) with a perimetrical line marking (3). Drawing No. 3 depicts a frozen challah (1) with a perimetrical groove (3). Drawing No. 4 depicts a frozen challah (1) with a small piece (4) separated from it.

The fact that the dough used to make the frozen challah (1) is in a frozen state enables to easily and efficiently separate a small portion of dough from the challah for the Hafrashat Challah Mitzvah, using the protrusion (2), the marking (3) or the separated piece (4). The protrusion (2) or the marking (3) or the separated piece (4) also enable to separate the challah portion without affecting the shape of the frozen challah (1). Furthermore, since the challah dough is in a frozen state and if the user waits until it defrosts to set aside the separated piece, the challah's shape might be affected, because by then the dough will be soft and sticky.

The size of the protrusion (2), the part with the marking (3) and of the separated small piece (4) which are designed to be removed before baking as mentioned above can be of a small volume, due to the fact that the Halacha regarding this amount is not specified and therefore any size is suitable for implementing the Mitsva. In practice the religious public use to remove a piece in a volume of about 10 cc from the dough and therefore it is possible that the size of the protrusion (2), the marking (3) part and the small piece (4) will be also about 10 cc.

The machines and equipments for preparing frozen dough shaped as challa or as bread are known to any expert in the filed. Also, the materials for preparing frozen challa and the way of preparation are also known to expert skilled in the art, and there are several manufacturers which produce and market frozen challa ready for baking. Thereof, it is understood that there is no need to describe this technology which is known to the experts in the filed. The way to create the protrusion (2) in one end of the frozen challa in a volume about 10 cc and the way to create the marking (3) of a part in one end of the frozen challa in a volume about 10 cc is very simple and understandable to any expert in the field, when he is commissioned to do so.

It is possible for example to create the protrusion (2) and the marking (3) by hands after the machine finishes to shape the challa, when the dough is still soft and before freezing. It is also possible to make the protrusion (2) and the marking (3) by machines, preferably, when the dough is still soft. It is known to the experts in the field that the machines for shaping the dough to challa include conveyor belt on which the pieces of dough are in a process of shaping also by mechanical arms. It is clearly understood to the professional experts in the field that in case of demand for creating protrusion (2) or marking (3) in the one end of the challa, while the dough is still soft, then it is possible to make it by additional sharp mechanical arm which intended to create the marking (3) in one end of the challa. The depth of such marking (3) depends on the position of such arm, and that is why it is possible to determine whether the marking (3) will be deep or shallow. When directing the said arm enters deeper into the dough it creates the protrusion (2).

As to the small piece (4), it is possible simply to add this mall piece (4) to one end of the challa and then to freeze them together. After freezing, it is possible to separate this small piece (4) by hands.

What is claimed is:

1. Frozen challah dough that is ready and intended for oven baking which has in one end of the said frozen challa a protrusion or piece of dough that intends to be removed before baking in the way that enables the user to perform the Hafrashat Challah Mitzvah.

2. Frozen challah dough that is ready and intended for oven baking which has in one end of the said frozen challa a small portion of the said frozen challah marked off, which intends to be remove before baking in the way that enables the user to perform the Hafrashat Challah Mitzvah.
